(19) United States
(12) Patent Application Publication
(10) Pub. No.: US 2021/0146180 A1
(43) Pub. Date: May 20, 2021

(54) Commercial Kitchen Fire Suppression System Having a Pressurized Canister Containing a Fire Extinguishing Agent Which Employs Internal Pressure to Actuate the Canister

(71) Applicant: Captive-Aire Systems, Inc., Raleigh, NC (US)

(72) Inventors: William Brian Griffin, Columbia, PA (US); L. Kenneth Bray, III, Leola, PA (US); Nikhil Ramesh, Downingtown, PA (US)

(73) Assignee: Captive-Aire Systems, Inc., Raleigh, NC (US)

(21) Appl. No.: 16/687,740

(22) Filed: Nov. 19, 2019

(51) Int. Cl. A62C 37/44; A62C 3/00

(52) U.S. Cl. CPC A62C 37/44; A62C 3/006

(57) ABSTRACT

The present invention relates to a fire extinguishing system for a commercial kitchen. The fire extinguishing system comprises a canister containing a fire extinguishing agent and a gas expellant. In the event of a fire or conditions that pose a threat of a fire, the internal pressure in the canister is utilized to actuate a main control valve of the canister which releases the fire extinguishing agent from the canister.

### FIELD OF THE INVENTION

The present invention relates to commercial kitchen fire suppression systems and systems for actuating canisters containing a fire extinguishing agent.

### BACKGROUND

To conform to various safety regulations, commercial kitchens must include integrated fire suppression systems. Typically conventional exhaust hoods found in commercial kitchens include means for detecting a fire, as well as a piping and nozzle distribution network for dispersing a fire extinguishing agent in and around an exhaust hood and an underlying cooking unit. Typically the fire extinguishing agent, along with a gas expellant, is contained in a pressurized canister. When a fire is sensed or conditions exist that pose a potential for a fire, the pressurized canister is actuated, releasing the fire extinguishing agent which is directed to the area of the fire by the piping and nozzle distribution network.

In the past, an external source or mechanism has been employed to actuate the main control valve of the canister and cause the release of the fire extinguishing agent. This adds additional cost and complexity to the system.

There is a need for a more simple, cost effective and efficient way of actuating a canister containing a fire extinguishing agent and forming a part of a commercial kitchen fire extinguishing system.

### SUMMARY OF THE INVENTION

The present invention aims to eliminate the need for external devices and pressure sources for opening the main control valve of the canister. As described, in the present invention the internal pressure within the canister containing the fire extinguishing agent and gas expellant is employed to actuate and open the main control valve of the canister that forms a part of the fire suppression system and which causes the release of the fire extinguishing agent in the canister.

In one particular embodiment of the present invention, a control or activation line extends from the canister to the main control valve. A solenoid valve is operatively connected in the activation line and when in a normal state causes the activation line to be closed such that the main control valve is not exposed to the internal pressure of the canister. Upon the occurrence of a fire or the presence of conditions that pose a potential for a fire, a fire signal is directed to the solenoid valve. The solenoid valve is energized and its state is changed to where the activation line is open, exposing the main control valve of the canister to the internal pressure of the canister. This pressure acts upon the main control valve, opening the main control valve and causing the fire extinguishing agent in the canister to be expelled through the main control valve of the canister.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of the fire suppression system of the present invention.

FIG. 1A is a view similar to FIG. 1 but illustrates how the pressure in one canister can be utilized to actuate one or more other canisters.

FIG. 2 is a perspective view of a typical hood found in a commercial kitchen.

FIG. 3 is a schematic illustration of the fire suppression system of the present invention particularly illustrating a pressurized canister containing a fire extinguishing agent and a pipe and nozzle distribution network for dispensing the fire suppression agent in a commercial kitchen environment.

### DESCRIPTION OF EXEMPLARY EMBODIMENTS

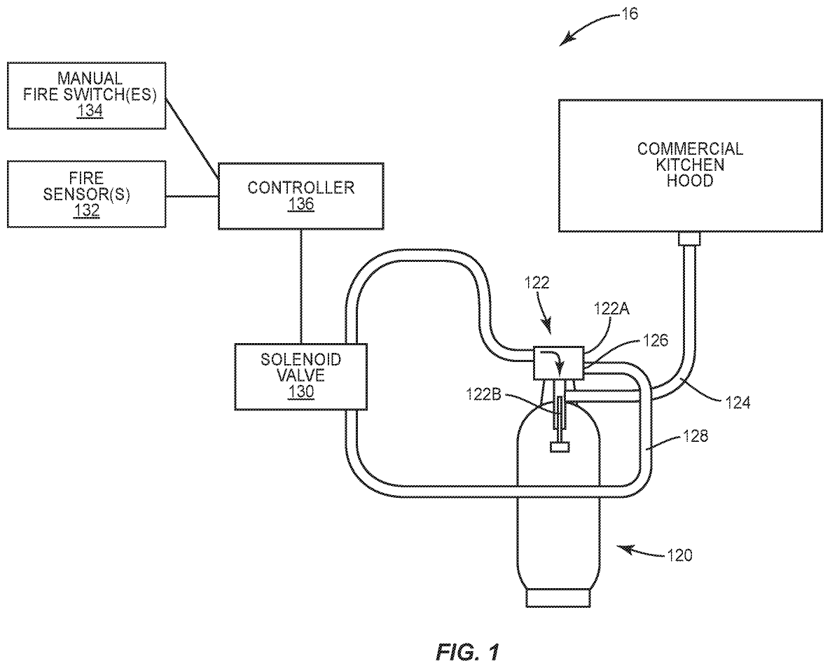

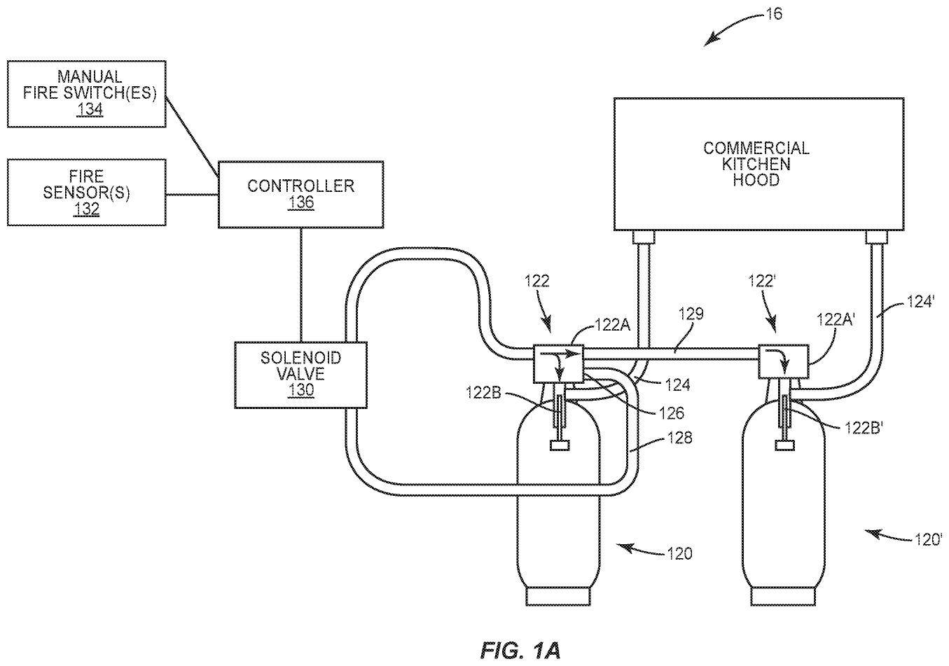

The present invention relates to a fire suppression system for a commercial kitchen. The fire suppression system is designed to distribute a fire extinguishing agent to various areas of the commercial kitchen, such as exhaust hoods, surface cooking units, etc. in the case of a fire. The fire extinguishing agent, along with a gas expellant, is contained in a pressurized canister indicated generally by the numeral 120. Canister 120 includes a pressure actuated main control valve 122. This valve is normally closed and maintains the fire extinguishing agent in the canister 120. As discussed below, control valve 122 can be actuated and caused to move to an open position, allowing the fire extinguishing agent to pass through the valve and from the canister 120 through an outlet line 124. See FIG. 1. Canister 120 is also provided with a pressure outlet 126. A pressure line 128 extends from the pressure outlet 126 to the main control valve 122.

The pressure activated main control valve includes a housing 122A and a slideable valve stem 122B which is schematically shown in FIG. 1. It is appreciated that there are numerous known pressure actuated control valves that could be employed with the canister 120 and that the example shown in FIG. 1 and described herein is just one of many options. Hence, details of the pressure activated control valve 122 are not dealt with here in detail because such valves are known and are not per se material to the present invention. Suffice it to say that the example shown in FIG. 1 shows a linear valve. With a linear valve, air pressure acts on a piston or a bellows diaphragm creating a linear force on a valve stem. The movement of the valve stem opens the control valve 122 and permits the fire extinguishing agent to be expelled through the valve and from the canister 120 into the outlet line 124.

In the particular embodiment illustrated herein, the main control valve 122 includes a pressure port 126. The pressure port 126 is normally open to the tank pressure.

An electrical solenoid valve 130 is connected in pressure line 128 between the pressure outlet 126 and the housing 122A of the main control valve 122. The function of the solenoid valve 130 is to control the actuation and opening of the main control valve 122. As discussed above, normally the main control valve 122 is closed and the solenoid valve 130 functions to isolate the main control valve from the pressure in the canister 120. Effectively, the valve portion of the solenoid valve is closed such that there is no downward pressure (opening pressure) being exerted on the main control valve as viewed in FIG. 1. In the embodiment illustrated herein, during this normal mode the solenoid valve is closed.

The actuation of the solenoid valve changes its state from closed to open. This effectively opens the valve portion of the solenoid valve 130 and enables the main control valve 122 to be exposed to the pressure within the canister 120 via line 128. That is, when the solenoid valve is energized, the valve portion thereof assumes an open position that permits gas expellant to move from pressure outlet 126 through line 128 into the housing 122A of the main control valve. Therefore, effectively the pressure in the housing 122A is generally equal to the tank pressure. This pressure will cause the valve stem 122B to move to an open position, allowing the fire extinguishing agent to move through the main control valve 122 into line 124. The pressure activated valve 122 is selected such that a normal range of pressures found in the canister 120 is sufficient to apply a force to the main control valve to open the same.

There are numerous ways to energize and actuate the solenoid valve 130 when there is a fire or a threat of a fire in a commercial kitchen. Generally this is accomplished by directing what is referred to as a fire signal to the solenoid valve 130. Various devices can be employed to generate this fire signal. One such device is illustrated in FIG. 1 is a fire sensor 132. Fire sensor or sensors 132 can be strategically placed in and around various appliances and equipment in the commercial kitchen. For example, the fire sensor 132 can be placed in a portion of the exhaust hood and/or a duct leading from the exhaust hood. Another example is a manual fire switch 134. Manual fire switch 134 can be located in the commercial kitchen and in the general vicinity of the surface cooking units and exhaust hoods. These devices are actuated manually in the event of a fire.

In one example, the fire sensor 132 and the manual fire switch 134 can be employed to directly actuate the solenoid valve 130. That is, both the fire sensor 132 and the manual fire switch 134 can be capable of generating the fire signal that is directed to the solenoid valve 130 and which actuates the same. In the embodiment illustrated in FIG. 1 however, the signals generated by the fire sensor 132 and the manual fire switch 134 is directed to a programmable controller 136. The programmable controller is in turn operatively connected to the solenoid valve 130. Programmable controller 136 typically controls various functions and monitors various subsystems in the commercial kitchen. As illustrated in FIG. 1, the programmable controller 136 is programmed to confirm the validity of the signal received by the fire sensor 132 or the manual fire switch 134 in the event of a fire. In any event, the signals generated by the fire sensor 132 and the manual fire switch 134 are relayed to the solenoid valve 130 via the programmable controller 136. As discussed above, once the solenoid valve 130 is actuated, its state is changed from close to open and this enables the main control valve 122 to be pressurized by the tank pressure.

Canister 120 can be located in various parts of the commercial kitchen or in adjacent areas. Typically the canister 120 is housed within a utility cabinet in the commercial kitchen or located at an area in close proximity to the commercial kitchen.

FIG. 1A illustrates how the pressure in the canister 120 can be used to actuate one or more other canisters that are ganged together. As shown in FIG. 1A, canister 120 is employed to actuate canister 120′. It is appreciated that so long as the pressure in canister 120 is sufficient, it can activate any number of downstream canisters. Note in FIG. 1A where there is a connecting pressure line 129 that is communicatively connected to the housing 122A and extends therefrom to where it is communicatively connected to housing 122A′ that forms a part of the control valve 122′ for the downstream canister 120′. Thus, when the solenoid valve 130 pressurizes control valve 122, the same pressure is effected to pressurize the control valve 122′ of the downstream canister 120′. This opens control valve 122′ and causes the fire extinguishing agent in canister 120′ to be released into line 124′. Line 124′ can be fed into line 124 or may be directed to other areas in the commercial kitchen. Thus, the canister 120′ and any other downstream canisters can be referred to as slave canisters. Note that only one solenoid valve 130 is required to actuate a plurality of canisters. In one embodiment, there can be up to three slave pressurized canisters per master (master+three slaves) activated by a single solenoid valve.

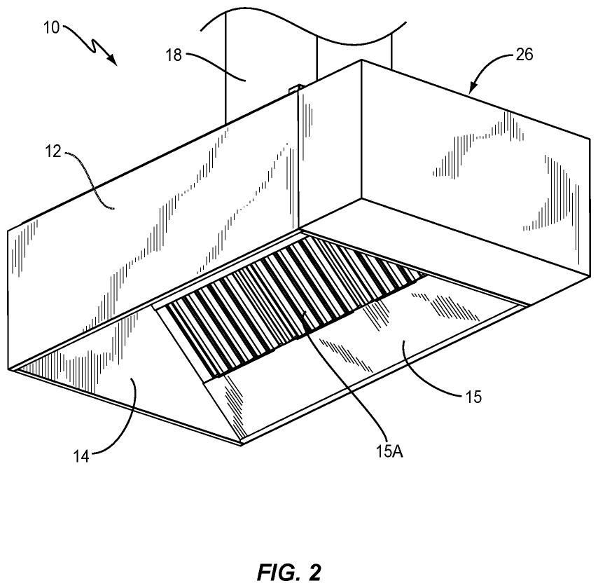

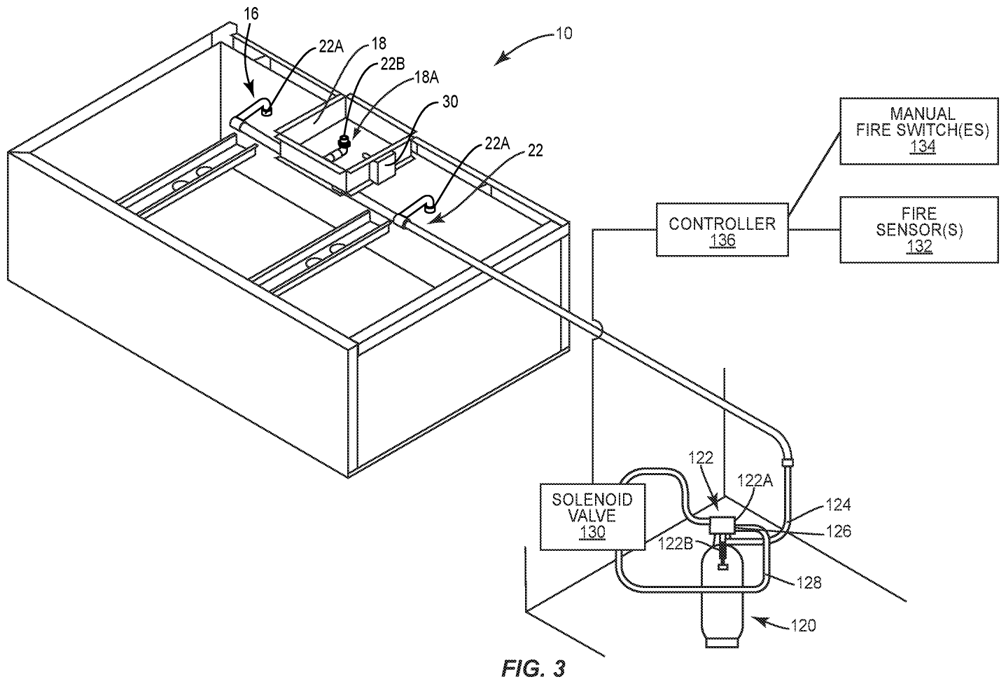

Outlet pipe 124 is operatively connected to a pipe and nozzle distribution network. (FIG. 3). This pipe and nozzle distribution network disperses the fire extinguishing agent into select areas of the commercial kitchen. That is, the pipe and nozzle distribution network can be extended to and through various areas of the commercial kitchen and in and around various appliances and equipment, such as exhaust hoods. FIGS. 2 and 3 show an exhaust hood and illustrate how the pipe and nozzle distribution network can be configured in the case of an exhaust hood.

Viewing the exhaust hood 10 in FIG. 2, note that it includes a housing 12. Housing 12 encloses a vapor entrainment area 14 comprising a portion of the interior of the housing as illustrated in FIG. 2. In a typical application, the kitchen hood assembly is mounted such that it is spaced above a cooking surface in order that vapors produced are entrained upwards into the vapor entrainment area 14. The kitchen hood 10 further includes a grease confinement area 16 (see FIG. 3) that is separated from the vapor entrainment area 14 by an incline panel 15 (see FIG. 2). Mounted within panel 15 is a filter 15A through which the entrained vapors flow into the grease confinement area 16. Mounted to the upper portion of the hood 10 and in fluid communication with grease confinement area 16 is a riser 18 that extends away from the hood. Riser 18 includes an interior 18A that receives vapors from the grease confinement area 16 and conducts those vapors away from the hood 10. See FIG. 3. An exhaust blower (not shown) is disposed in fluid communication with the riser 18. The exhaust blower maintains a draft through riser 18 to facilitate in trapping vapor in the vapor entrainment area 14 and directing the vapors through filter 15A into the grease confinement area 16 and subsequently through riser 18 to be exhausted away from the hood 10.

As particularly illustrated in FIG. 3, the pipe and nozzle network for distributing or dispersing the fire extinguishing agent is shown incorporated into the hood 10. The pipe and nozzle network includes a spray bar 22 that extends transversely across an upper portion of the grease confinement area 16. See FIG. 3. Spray bar 22 includes a series of spaced apart nozzles 22A and at least one riser nozzle 22B. It is appreciated that the number of nozzles employed can vary as they can be strategically placed throughout the commercial kitchen hood and even places outside of the kitchen hood. In any event, there would be at least one riser nozzle and one plenum nozzle. Nozzles 22A are typically angled to direct the fire extinguishing agent to the inner surfaces of the grease confinement area 16. Nozzles 22A may be directed at various angles. Each nozzle 22A has a spray pattern, spacing and direction such that the area of concern is well covered by the layout of the spray pipe 22 and the nozzles.

It is important to appreciate that the exemplary application of the present invention, as shown in FIGS. 2 and 3 and as discussed herein, is simply one particular way of employing the fire suppression system in a commercial kitchen. There are other particular ways in which the pipe and nozzle network can be designed and implemented to provide ample coverage to those areas in and around appliances and equipment where there is a fire or conditions that can give rise to a fire. For example, see the disclosure found in U.S. Pat. No. 8,378,834. The content of this patent and the disclosures therein is expressly incorporated herein by reference.

There are numerous advantages of the present invention. Employing the pressure in the canister 120 to actuate the main control valve 122 eliminates the need for an external pressure source or an external device to actuate the valve. This greatly simplifies the system and reduces the cost.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A method of automatically emitting a fire extinguishing agent into a commercial kitchen in response to a fire or conditions in the commercial kitchen that pose a potential for a fire wherein the fire extinguishing agent and a gas expellant are contained in a pressurized canister having a pressure outlet and a pressure activated main control valve for controlling the flow of the fire extinguishing agent from the canister, the method comprising:
in response to a fire in the commercial kitchen, directing a fire signal to a solenoid valve connected in a line leading from the pressure outlet to the pressure activated main control valve of the canister;
employing the fire signal to actuate the solenoid valve;
upon actuation of the solenoid valve, exposing the main control valve to the internal pressure of the canister;
employing the internal pressure of the canister to actuate and open the main control valve; and
after the main control valve is opened, directing the fire extinguishing agent from the canister through the main control valve and into a fire extinguishing distribution network that extends into a kitchen hood structure in the commercial kitchen.

2. The method of claim 1 wherein the solenoid valve includes a valve portion that is normally closed and prevents the gas expellant in the canister from flowing to the main control valve; and wherein when the valve portion assumes an open position, gas expellant under pressure flows from the canister through the open solenoid valve to the main control valve and causes the main control valve to open, releasing the fire extinguishing agent from the canister via the main control valve.

3. The method of claim 1 wherein a second canister containing a fire extinguishing agent and a gas expellant is operatively connected to said canister, and wherein the method further includes employing the internal pressure in said canister to actuate a second control valve associated with the second canister.

4. The method of claim 3 wherein a pressure line is communicatively connected between said main control valve and the second control valve, and wherein the method includes pressurizing the second control valve via the pressure line in response to a fire signal being received by the solenoid valve.

5. The method of claim 4 wherein said main control valve and the second control valve each include a housing and wherein the pressure line is open to each of the housings such that, upon actuation of the main control valve, the pressures within the housings are substantially equal.

6. A fire suppression system for a commercial kitchen comprising:
the commercial kitchen including appliances and/or equipment;
a pressurized canister containing a fire extinguishing agent and a gas expellant;
the pressurized canister including a pressure actuated main control valve having a housing for controlling the flow of the fire extinguishing agent from the canister;
a canister pressure outlet;
a pressure line operatively connected between the canister pressure outlet and the main control valve;
a solenoid valve connected in the pressure line between the canister pressure outlet and the housing of the main control valve and wherein the solenoid valve is configured to assume a normal state that closes the pressure line and isolates the canister pressure from the main control valve;
a fire detection device or controller configured to direct a fire signal to the solenoid valve where the fire signal represents the occurrence of a fire in the commercial kitchen;
wherein the solenoid valve, in response to receiving the fire signal, is configured to open the pressure line between the canister pressure outlet and the housing of the main control valve such that the pressure in the canister acts on the main control valve to open the main control valve and cause the fire extinguishing agent to be dispersed from the canister;
a distribution network operatively connected to the canister for directing the fire extinguishing agent into the commercial kitchen; and
wherein the canister employs the pressure within the canister to actuate the main control valve of the canister.

7. The fire extinguishing system of claim 6 including a second canister containing a fire extinguishing agent and a gas expellant and including a second control valve, and wherein the second canister is operatively connected to said canister and wherein said canister and the second canister are configured such that the pressure within said canister is employed to actuate the second control valve of the second canister.

8. The fire extinguishing system of claim 7 wherein a second pressure line is operatively connected between said main control valve and the second control valve associated with said second canister and wherein said second pressure line is configured to pressurize the second control valve when the main control valve is pressurized.

9. A method of extinguishing a fire in a commercial kitchen with a fire extinguishing system comprising a first pressurized canister containing a fire extinguishing agent and a gas expellant and a second pressurized canister containing a second fire extinguishing agent and a second gas expellant, the method comprising:
in the event of a fire in the commercial kitchen, actuating said first canister by employing the internal pressure of the first canister to open a first control valve associated with the first canister, releasing the fire extinguishing agent from the first canister and directing the fire extinguishing agent from the first canister to a location in the commercial kitchen; and
upon the actuation of said first canister, actuating said second canister by employing the internal pressure of said first canister to open a second control valve associate with the second canister, releasing the second fire extinguishing agent from the second canister and directing the second fire extinguishing agent from the second canister to said location in the commercial kitchen or to another location.

10. The method of claim 9 wherein a pressure line is operatively connected between the first control valve of the first canister and the second control valve of the second canister and wherein the second control valve is pressurized and opened via the pressure line when the first control valve is pressurized by the internal pressure within the first canister.

11. The method of claim 10 wherein the first control valve includes a first housing and the second control valve includes a second housing and wherein the pressure line is connected between the first and second housings and is open to internal spaces within the first and second housings.
